(19) United States
(12) Patent Application Publication
(10) Pub. No.: US 2024/0199242 A1
(43) Pub. Date: Jun. 20, 2024

(54) PACKAGE DELIVERY SYSTEM, PACKAGE DELIVERY CONTROL APPARATUS, AND PACKAGE DELIVERY METHOD

(71) Applicant: JVCKENWOOD Corporation, Yokohama-shi (JP)

(72) Inventors: Yudai Sakurada, Yokohama-shi (JP); Junichi Kasuya, Yokohama-shi (JP); Kodai Nakamura, Yokohama-shi (JP); Ren Watanabe, Yokohama-shi (JP)

(21) Appl. No.: 18/588,012

(22) Filed: Feb. 27, 2024

Related U.S. Application Data
(63) Continuation of application No. PCT/JP2022/013751, filed on Mar. 23, 2022.

(30) Foreign Application Priority Data
Sep. 2, 2021 (JP) 2021-142963

(51) Int. Cl. B64U 20/80; B64U 101/64; G05D 1/228; G05D 1/48; G05D 1/667; G05D 105/28; G05D 109/25

(52) U.S. Cl. CPC B64U 20/80; G05D 1/228; G05D 1/48; G05D 1/667; B64U 2101/64; G05D 2105/285; G05D 2109/254

(57) ABSTRACT

A package delivery system includes a drone that delivers a package and a package delivery control apparatus, and further includes a communication control unit that transmits a delivery code of the package to a terminal apparatus that has placed an order for delivery of the package, an irradiation control unit causes the drone to emit light in which the delivery code is superimposed when the drone arrives at a destination, and a drone control unit that, when the delivery code that the terminal apparatus has acquired by transmission from the communication control unit and the delivery code that is acquired by receiving light emitted from the drone match with each other, approves the terminal apparatus to cause the drone to perform operation of releasing the package.

### CROSS-REFERENCE TO RELATED APPLICATIONS

This application is a Continuation of PCT International Application No. PCT/JP2022/013751 filed on Mar. 23, 2022 which claims the benefit of priority from Japanese Patent Application No. 2021-142963 filed on Sep. 2, 2021, the entire contents of both of which are incorporated herein by reference.

### BACKGROUND

### 1. Technical Field

The present disclosure relates to a package delivery system, a package delivery control apparatus, and a package delivery method.

### 2. Description of the Related Art

Delivery of a package by using a drone is disclosed (for example, Japanese Translation of PCT International Application Publication No. 2018-531174 and U.S. Patent Application Publication No. 2020/0094962 Specification).

In the technologies described in Japanese Translation of PCT International Application Publication No. 2018-531174 and U.S. Patent Application Publication No. 2020/0094962 Specification, when a package is delivered by using a drone, the package released from the drone may unintentionally fall or the package may be placed on an inappropriate location. Further, depending on impact resistance of the package, a receiver may want to manually secure the package. Therefore, it is desired to allow the receiver of the package to designate release of the package from the drone.

### SUMMARY

It is an object of the present disclosure to at least partially solve the problems in the conventional technology.

A package delivery system according to the present disclosure includes a drone that delivers a package by adopting a designated delivery location of the package as a destination, and a package delivery control apparatus that is able to perform communication with the drone and a terminal apparatus that is designated by an orderer of the package. The package delivery system includes a communication control unit that transmits a delivery code of the package to the terminal apparatus when receiving an order for delivery of the package, an irradiation control unit that causes the drone to emit light in which the delivery code is superimposed when the drone arrives at the destination, a drone control unit that, when the delivery code that the terminal apparatus has acquired by transmission from the communication control unit and the delivery code that the terminal apparatus has acquired by receiving light emitted from the drone match with each other, approves the terminal apparatus to cause the drone to perform operation of releasing the package, and instructs the drone to release the package based on information that indicates operation of releasing the package and that is received from the terminal apparatus, and a release control unit that, when receiving, from the package delivery control apparatus, information that indicates operation of releasing the package, performs control so as to perform operation of releasing the package.

A package delivery control apparatus according to the present disclosure includes a communication control unit that controls communication between a terminal apparatus that is designated by an orderer who places an order for delivery of a package and a drone that delivers the package, and a drone control unit that controls operation of the drone by communication performed by the communication control unit. The communication control unit, when receiving an order for delivery of the package, transmits a delivery code that includes designated delivery location information on the package to the terminal apparatus that is designated by an orderer of the package, and the drone control unit, when the drone that delivers the package arrives at a destination that is based on the designated delivery location information on the package, causes the drone 10 to emit light in which the delivery code is superimposed, approves the terminal apparatus to cause the drone to perform operation of releasing the package when acquiring information indicating that the delivery code that the terminal apparatus has acquired by transmission from the communication control unit and the delivery code that the terminal apparatus has acquired by receiving light emitted from the drone match with each other, and instructs the drone to perform operation of releasing the package based on information that indicates the operation of releasing the package and that is received from the terminal apparatus.

A package delivery method implemented by a package delivery control apparatus that is able to perform communication with a terminal apparatus that is designated by an orderer who places an order for delivery of a package and a drone that delivers the package is disclosed. The package delivery method includes transmitting a delivery code of the package to the terminal apparatus when receiving an order for delivery of the package, causing the drone to emit light in which the delivery code is superimposed when the drone arrives at the destination, approving, when the delivery code that the terminal apparatus has acquired at the time of the order of the package and the delivery code that the terminal apparatus has acquired by receiving light emitted from the drone match with each other, the terminal apparatus to cause the drone to perform operation of releasing the package, and instructing the drone to release the package based on information that indicates operation of releasing the package and that is received from the terminal apparatus.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic diagram of a package delivery system according to a first embodiment;

FIG. 2 is a schematic diagram of a drone;

FIG. 3 is a block diagram of the drone;

FIG. 4 is a block diagram of a package delivery control apparatus;

FIG. 5 is a block diagram of a terminal apparatus;

FIG. 6 is a diagram illustrating an example of a release instruction screen that is displayed on a display screen;

FIG. 7 is a diagram illustrating the flow of an order placement process performed by the package delivery system according to the first embodiment;

FIG. 8 is a diagram illustrating the flow of an order receipt process performed by a package delivery control apparatus in the package delivery system according to the first embodiment;

FIG. 9 is a diagram illustrating the flow of a delivery process performed by the terminal apparatus in the package delivery system according to the first embodiment;

FIG. 10 is a diagram illustrating the flow of a delivery process performed by the package delivery control apparatus in the package delivery system according to the first embodiment;

FIG. 11 is a diagram illustrating the flow of a delivery process performed by the drone in the package delivery system according to the first embodiment; and

FIG. 12 is a schematic diagram of a drone according to a second embodiment.

### DETAILED DESCRIPTION OF THE PREFERRED EMBODIMENTS

Embodiments of a package delivery system, a package delivery control apparatus, and a package delivery method according to the present disclosure will be described in detail below with reference to the accompanying drawings. The present disclosure is not limited by the embodiments below.

### First Embodiment

### Package Delivery System

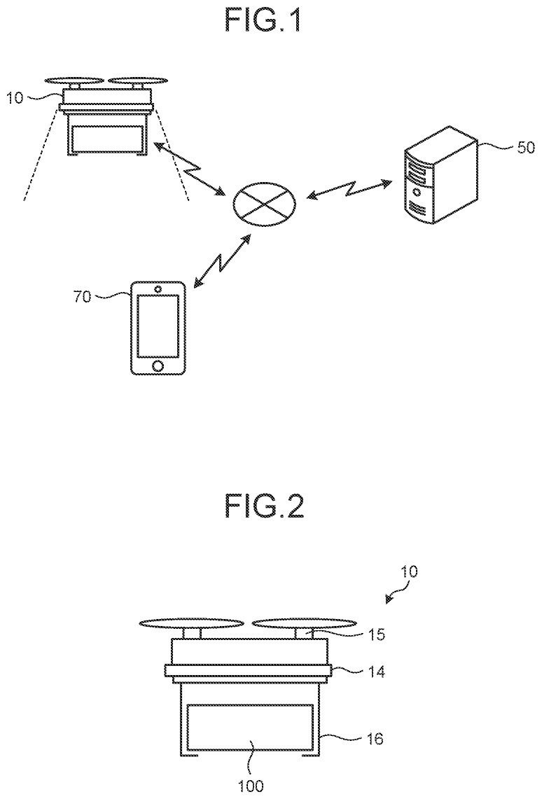

FIG. 1 is a schematic diagram of a package delivery system 1 according to a first embodiment. The package delivery system 1 is a system that delivers package by using a drone 10. The package delivery system 1 allows a receiver to control release of a package when the package is released from the drone 10 at a destination. The package delivery system 1 includes the drone 10 and a package delivery control apparatus 50. In the present embodiment, the package delivery system 1 includes the drone 10, the package delivery control apparatus 50, and a terminal apparatus 70. The drone 10, the package delivery control apparatus 50, and the terminal apparatus 70 are able to communicate information with one another via a network.

### Drone

FIG. 2 is a schematic diagram of the drone 10. The drone 10 includes a driving unit 15 for flight, a light source unit 14 for performing optical wireless communication, and a release mechanism 16 for releasing a package from a package holding state. FIG. 2 illustrates a state in which a package 100 is being held. The drone 10 is an unmanned aerial vehicle that delivers a package to a destination. The drone 10 delivers a package while adopting designated delivery location information that indicates a designated delivery location of the package as a destination. The drone 10 may autonomously flies to the destination, for example. The drone 10 may fly to the destination by being operated by an operator via a remote controller. The drone 10 may fly to the destination by combination of autonomous flight and operation by an operator. In the description below, explanation will be given based on the assumption that the drone 10 autonomously flies to the destination.

The drone 10 flies to the destination while holding a package on a main body. The package is held by, for example, arms that extend from the main body. As a method of holding the package by the drone 10, a well-known method is available, and the method is not specifically limited. The drone 10, when arriving at the destination, releases the package by being controlled by the terminal apparatus 70 that is used by a receiver.

The package may be transported from a business office of a delivery source, a delivery company, or the like to the destination by the drone 10, for example. The package may be transported by, for example, a vehicle from the business office of the delivery company to a certain location that is a few kilometers (km) before the destination, and may be delivered from the certain location to the destination by the drone 10.

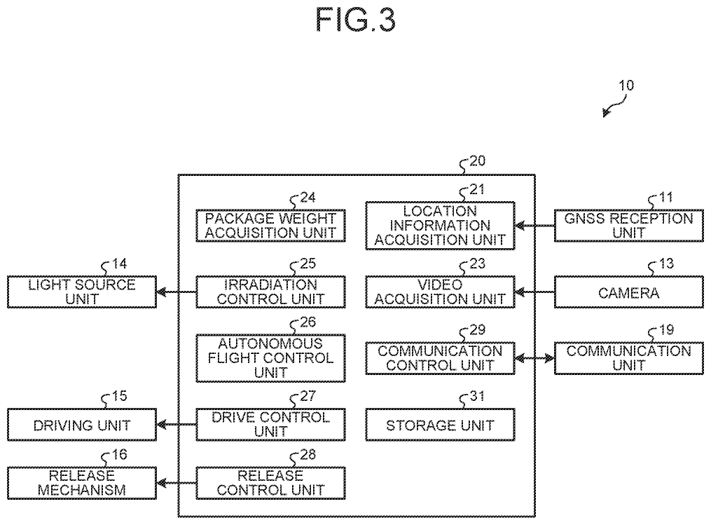

FIG. 3 is a block diagram of the drone 10. The drone 10 includes a Global Navigation Satellite System (GNSS) reception unit 11, a camera 13, the light source unit 14, the driving unit 15, the release mechanism 16, a communication unit 19, and a control unit 20. The drone 10 is able to communicate information with the package delivery control apparatus 50 via a network by using the communication unit 19 that is controlled by a communication control unit 29.

The GNSS reception unit 11 receives a GNSS signal from a GNSS satellite. The GNSS reception unit 11 outputs the received GNSS signal to a location information acquisition unit 21 of the control unit 20. The GNSS reception unit 11 is configured with, for example, a GNSS reception circuit, an antenna, and the like that are able to receive the GNSS signal.

The camera 13 is a camera that capture a video around the drone 10. The camera 13 captures an image around the destination. In the present embodiment, the camera 13 captures a video that is used to control autonomous flight of the drone 10. The camera 13 is mounted on the drone 10. The camera 13 is arranged on the main body of the drone 10 with face down, for example. The camera 13 continuously capture videos during a period from start of flight of the drone 10 to end of the flight, for example. The camera 13 outputs the captured video to a video acquisition unit 23 of the control unit 20.

The light source unit 14 is a light source that performs optical wireless communication. The light source unit 14 is, for example, a light source for Light Emitting Diode (LED) light. The light source unit 14 is a light source that emits light from the drone 10. More specifically, the light source unit 14 emits light in which a delivery code is superimposed (hereinafter, referred to as “delivery code superimposed light”). In the present embodiment, the light source unit 14 emits the delivery code superimposed light that is received from the package delivery control apparatus 50 via the communication control unit 29. The light source unit 14 emits light around the drone 10 and downward relative to the horizontal direction. The light source unit 14 encodes the delivery code by a 4-bit signal, an 8-bit signal, or the like with respect to light that is emitted from an LED light source, for example. Further, the light source unit 14, when LED light is subjected to Pulse Width Modulation (PWM) dimming at 100 Hz for example, superimposes the delivery code on a dimming pulse. The delivery code superimposed light includes header information indicating that the light includes the delivery code.

The delivery code is a code for uniquely identifying an order for the package, and may include the designated delivery location information that indicates a designated delivery location of the package. The designated delivery location is indicated by, for example, a latitude and a longitude. The delivery code may include, for example, information that indicates at least any one of the receiver and the designated delivery date and time. The delivery code may include, for example, a weight of the package, a size of the package, a type of the package, and the like. The designated delivery location is a destination of the drone 10.

The driving unit 15 is a motor that causes the drone 10 to fly. The driving unit 15 is, for example, a motor that controls rotation of a propeller of the drone 10. Rotation of the driving unit 15 is controlled by a control signal from a drive control unit 27 of the control unit 20. By controlling the rotation of the driving unit 15, the drone 10 performs various kinds of flight operation, such as takeoff and landing, forward movement, circling, upward movement, downward movement, and hovering.

The release mechanism 16 is a driving mechanism that includes an actuator, a motor, or the like that causes a holder unit holding the package in the drone 10 to operate. The release mechanism 16 is, for example, an actuator that operates an arm that holds the package in the drone 10. The release mechanism 16 is controlled by a control signal from a release control unit 28 of the control unit 20. By controlling the release mechanism 16, holding and release of the package are switched from one to the other.

The communication unit 19 is a communication unit that performs wide area wireless communication. The communication unit 19 communicates information with the package delivery control apparatus 50 via a network, for example. The network is, for example, the Internet network, but not limited thereto. The communication unit 19 is configured with, for example, a wide area wireless communication module for a mobile phone network. The communication unit 19 may be configured with a communication module for Wi-Fi (registered trademark) or the like, and may realize wide area wireless communication by connecting to an arbitrary access point, a different smartphone, or the like.

### Control Unit

The control unit 20 is, for example, an arithmetic processing device (control device) that includes a Central Processing Unit (CPU) or the like. The control unit 20 loads a stored program onto a memory and executes a command that is included in the program. The control unit 20 includes an internal memory (not illustrated), and the internal memory is used to temporarily store therein data for the control unit 20. The control unit 20 controls the drone 10. The control unit 20 includes the location information acquisition unit 21, the video acquisition unit 23, a package weight acquisition unit 24, an irradiation control unit 25, an autonomous flight control unit 26, the drive control unit 27, the release control unit 28, the communication control unit 29, and a storage unit 31.

The location information acquisition unit 21 calculates a current location information on the drone 10 based on radio waves received by the GNSS reception unit 11.

The video acquisition unit 23 acquires a video that is captured by the camera 13. The video acquisition unit 23 outputs the acquired video to the irradiation control unit 25 and the autonomous flight control unit 26. The video acquisition unit 23 may store the acquired video in a storage device (not illustrated) or may output the acquired video to an external apparatus, such as a remote monitoring facility of a delivery company.

The package weight acquisition unit 24 acquires a weight of a package that is held by the drone 10. The package weight acquisition unit 24 may acquire the weight of the package from, for example, a weight sensor (not illustrated) that is arranged around the release mechanism 16. The package weight acquisition unit 24 may acquire the weight of the package from the delivery company together with the delivery code, for example.

The irradiation control unit 25 causes the drone 10 to emit light. More specifically, when the drone 10 arrives at the destination, the irradiation control unit 25 causes the light source unit 14 of the drone 10 to emit the delivery code superimposed light that is acquired from the package delivery control apparatus 50 via the communication control unit 29.

The irradiation control unit 25 may cause the drone 10 to emit the delivery code superimposed light when the drone 10 arrives at the destination and when the terminal apparatus 70 or a person is recognized by performing image processing on the video that is captured by the camera 13. As a process of recognizing an object, such as the terminal apparatus 70 or a person, from the video, a well-known technology is applicable and the process is not specifically limited.

The autonomous flight control unit 26 controls autonomous flight by adopting the designated delivery location of the package as a destination based on location information on a current location of the drone 10 that is acquired by the location information acquisition unit 21. More specifically, the autonomous flight control unit 26, when receiving information indicating a delivery instruction from the package delivery control apparatus 50, starts autonomous flight to the destination. First, the autonomous flight control unit 26 acquires, for example, the designated delivery location of the package from the delivery code that is acquired from the package delivery control apparatus 50 via the communication control unit 29. The autonomous flight control unit 26 searches for a flight route from the current location to the destination based on, for example, map information (not illustrated). The autonomous flight control unit 26 outputs a control signal to the drive control unit 27 such that the drone 10 autonomously flies to the destination along the retrieved flight route. The autonomous flight control unit 26 outputs a control signal that includes, for example, the retrieved flight route and a flight altitude to the drive control unit 27.

The autonomous flight control unit 26, when the drone 10 arrives at the destination, transmits information indicating that a delivery acceptable condition is met to the package delivery control apparatus 50 via the communication control unit 29. More specifically, the autonomous flight control unit 26 determines whether or not the delivery acceptable condition is met based on the current location of the drone 10 and the designated delivery location. If the location information on the drone 10 and the designated delivery location information indicating a latitude and a longitude of the destination match with each other based on the location information that is acquired by the location information acquisition unit 21 and the designated delivery location information, the autonomous flight control unit 26 determines that the drone 10 has arrived at the destination, that is, the delivery acceptable condition is met.

The autonomous flight control unit 26 may control autonomous flight to the destination based on the video that is acquired by the video acquisition unit 23, in addition to the location information. When image processing is performed on the video and if an obstacle is recognized in the path of the drone 10 for example, the autonomous flight control unit 26 outputs a control signal for avoiding the obstacle. If an obstacle is recognized from the video, the autonomous flight control unit 26 outputs a control signal that causes the drone 10 to circle, move upward, or move downward, for example.

In the present embodiment, the autonomous flight control unit 26 may cause the drone 10 to slowly fly while circling in order to detect the terminal apparatus 70 around the destination. More specifically, when it is determined that the drone 10 has arrived at the destination, the autonomous flight control unit 26 outputs a control signal that causes the drone 10 to slowly fly while circling around the destination.

In the present embodiment, the autonomous flight control unit 26 may cause the drone 10 to hover or move downward to a height of about 1 to 3 meters above ground to apply the delivery code superimposed light to the terminal apparatus 70 at the destination. Further, when image processing is performed on the video that is acquired by the video acquisition unit 23 and if it is determined that the terminal apparatus 70 is recognized, the autonomous flight control unit 26 outputs a control signal that causes the drone 10 to hover in the sky above the terminal apparatus 70 or a control signal that causes the drone 10 to descend to a height of about 1 m from the terminal apparatus 70.

In the present embodiment, when acquiring, from the package delivery control apparatus 50 via the communication control unit 29, operation information that is given from the terminal apparatus 70, the autonomous flight control unit 26 performs control while adding the operation information given from the terminal apparatus 70 to the control on the autonomous flight of the drone 10.

The drive control unit 27 outputs a control signal for controlling the driving unit 15. More specifically, the drive control unit 27 outputs a control signal for controlling the rotation of the propeller of the drone 10. The drive control unit 27 controls the driving unit 15 such that autonomous flight to location information that indicates a latitude and a longitude of the destination is performed based on the control signal output from the autonomous flight control unit 26.

In the present embodiment, the drive control unit 27 causes the drone 10 to fly to the destination. More specifically, the drive control unit 27 outputs a control signal that causes the drone 10 to fly to the destination, to the driving unit 15 based on the control signal output from the autonomous flight control unit 26. The drive control unit 27 outputs, to the driving unit 15, a control signal that causes the drone 10 to circle, move upward, or move downward, based on the control signal output from the autonomous flight control unit 26.

Alternatively, in the present embodiment, the drive control unit 27 causes the drone 10 to slowly fly while circling around the destination such that the terminal apparatus 70 can easily receive the delivery code superimposed light, based on the control signal output from the autonomous flight control unit 26. More specifically, the drive control unit 27 outputs, to the driving unit 15, a control signal that causes the drone 10 to slowly fly while circling around the destination, based on the control signal output from the autonomous flight control unit 26.

In the present embodiment, the drive control unit 27 causes the drone 10 to hover to apply the delivery code superimposed light to the terminal apparatus 70 at the destination based on the control signal output from the autonomous flight control unit 26. More specifically, the drive control unit 27 outputs, to the driving unit 15, a control signal that causes the drone 10 to hover in the sky above the terminal apparatus 70 or a control signal that causes the drone 10 to move downward, based on the control signal output from the autonomous flight control unit 26.

The release control unit 28 causes the release mechanism 16 to hold the package while the drone 10 is flying to the destination. The release control unit 28, when operation information for instructing operation of releasing the package is received from the terminal apparatus 70 via the package delivery control apparatus 50, performs control so as to release the package.

The release control unit 28, when receiving, from the package delivery control apparatus 50 via the communication control unit 29, the operation information on the release operation that is given from the terminal apparatus 70, outputs a control signal for controlling the release mechanism 16. More specifically, when receiving, from the package delivery control apparatus 50 via the communication control unit 29, the operation information on the release operation that is given from the terminal apparatus 70, for example, the release control unit 28 outputs a control signal for switching between holding and release of the package to the actuator that operates the arm that holds the package in the drone 10. In the present embodiment, when receiving, from the package delivery control apparatus 50 via the communication control unit 29, the operation information on the release operation that is given from the terminal apparatus 70, the release control unit 28 outputs a control signal for releasing the package to the release mechanism 16. For example, the release control unit 28 outputs a control signal for releasing the package to the actuator that operates the arm that holds the package in the drone 10.

When receiving operation information indicating operation of finely adjusting a delivery position of the package from the terminal apparatus 70, the release control unit 28 performs control so as to perform release operation after finely adjusting a delivery position of the package.

The communication control unit 29 controls the communication unit 19 and controls communication with the package delivery control apparatus 50. In the present embodiment, the communication control unit 29 receives the delivery code from the package delivery control apparatus 50. The communication control unit 29, if a delivery preparation for the package is completed, transmits delivery preparation completion information that indicates completion of the delivery preparation to the package delivery control apparatus 50. The communication control unit 29 receives information indicating a delivery instruction from the package delivery control apparatus 50. The communication control unit 29 transmits information indicating that the delivery acceptable condition is met to the package delivery control apparatus 50. The communication control unit 29 receives the operation information that is input by the terminal apparatus 70, for example, the operation information indicating designation of the release operation, from the package delivery control apparatus 50.

The storage unit 31 is a storage device that stores therein a program, data, and the like that are used by, the control unit 20. As the storage unit 31, for example, at least one of a non-volatile semiconductor memory and a volatile semiconductor memory, such as a Read Only Memory (RAM), a Random Access Memory (ROM), a flash memory, an Erasable Programmable Read Only Memory (EPROM), and an Electrically Erasable Programmable Read Only Memory (EEPROM), is used.

### Package Delivery Control Apparatus

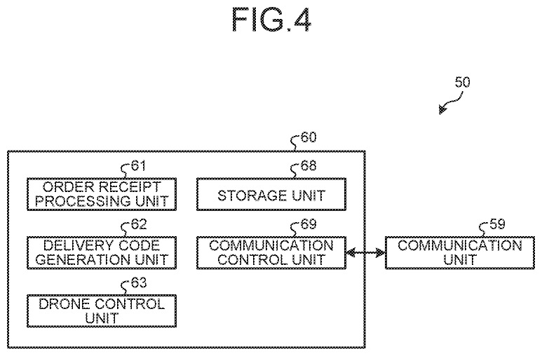

FIG. 4 is a block diagram of the package delivery control apparatus 50. The package delivery control apparatus 50 is a server apparatus that is managed or used by a business operator who performs electronic commerce or a package delivery operator, and may include a plurality of server apparatuses. The package delivery control apparatus 50 is able to communicate information with the drone 10 and the terminal apparatus 70 via a network. The package delivery control apparatus 50 performs the order receipt process for package delivery and a package delivery process. The package delivery control apparatus 50 includes a communication unit 59 and a control unit 60.

The communication unit 59 is a communication unit that performs wide area wireless communication. The communication unit 59 communicates information with the drone 10 and the terminal apparatus 70 via a network, for example. The network is, for example, the Internet network, but not limited thereto. The communication unit 59 is configured with, for example, a wide area wireless communication module for a mobile phone network. The communication unit 59 may be configured with a communication module for Wi-Fi, or the like, and may realize wide area wireless communication by connecting to an arbitrary access point, a different smartphone, or the like.

### Control Unit

The control unit 60 is, for example, an arithmetic processing device (control device) that includes a CPU or the like. The control unit 60 loads a stored program onto a memory and executes a command that is included in the program. The control unit 60 includes an internal memory (not illustrated), and the internal memory is used to temporarily store therein data for the control unit 60. The control unit 60 controls the package delivery control apparatus 50. The control unit 60 includes an order receipt processing unit 61, a delivery code generation unit 62, a drone control unit 63, a storage unit 68, and a communication control unit 69.

The order receipt processing unit 61 receives an order of package delivery from, for example, the terminal apparatus 70, an external apparatus, or the like. The order receipt processing unit 61 receives, at the time of order receipt, the designated delivery location information that indicates the designated delivery location of the package from the terminal apparatus 70, an external apparatus, or the like. The order receipt processing unit 61 may receive, at the time of order receipt, information indicating any of a receiver of the package, a designated delivery date and time, a weight of the package, a size of the package, and a type of the package from the terminal apparatus 70, an external apparatus, or the like, together with the designated delivery location information, for example.

The delivery code generation unit 62, after the order receipt processing unit 61 receives the order of package delivery, generates a delivery code. The delivery code that is generated by the delivery code generation unit 62 is transmitted to the drone 10 that delivers the package and the terminal apparatus 70 that is designated by an orderer of the package, via the communication control unit 69.

The drone control unit 63, at the start of delivery of the package, outputs information indicating the delivery instruction to that is designated for delivery.

The drone control unit 63, at the time of delivery of the package, transmits a delivery acceptable notice indicating that delivery is acceptable, to the terminal apparatus 70 via the communication control unit 69. The drone control unit 63, when receiving information indicating that the delivery acceptable condition is met from the drone 10 via the communication control unit 69, transmits the delivery acceptable notice to the terminal apparatus 70.

The drone control unit 63, at the time of delivery of the package, grants a release right to the terminal apparatus 70. In the present embodiment, when the delivery code that is acquired by the terminal apparatus 70 by transmission from the communication control unit 69 and the delivery code that is acquired by the terminal apparatus 70 by reception of the light applied from the drone 10 match with each other, the drone control unit 63 approves the terminal apparatus 70 to cause the drone 10 to perform operation of releasing the package, and instructs the drone 10 to release the package based on information that indicates the operation of releasing the package and that is received from the terminal apparatus 70. More specifically, if the delivery code that the terminal apparatus 70 has acquired from the package delivery control apparatus 50 and the delivery code that the terminal apparatus 70 has acquired by receiving the light applied from the irradiation control unit 25 of the drone 10 via a light reception control unit 81, which are acquired from the terminal apparatus 70, match with each other, the drone control unit 63 transmits release operation approval information indicating granting of a right to release the package to the terminal apparatus 70. The drone control unit 63, if the two delivery codes that are acquired from the terminal apparatus 70 match with each other, transmits the release operation approval information to the terminal apparatus 70.

The drone control unit 63 may grant a right to finely adjust a position of the drone 10 to the terminal apparatus 70, in addition to granting the right to release the package. In the present embodiment, if the delivery code that the terminal apparatus 70 has acquired by transmission from the communication control unit 69 and the delivery code that the terminal apparatus 70 has acquired by receiving light emitted from the drone 10 match with each other, the drone control unit 63 approves the terminal apparatus 70 for operation of causing the drone 10 to finely adjust a delivery position of the package.

The drone control unit 63 outputs a control signal for controlling the drone 10 to the drone 10 that delivers the package. The drone control unit 63, when receiving the operation information from the terminal apparatus 70 via the communication control unit 69, transmits the operation information to the drone 10 via the communication control unit 69.

The drone control unit 63 may transmit information indicating designation of the release operation under a prescribed condition to the drone 10 via the communication control unit 69.

The prescribed condition is a condition that is determined in advance for performing the release operation, and is, for example, a condition that the package is released when hand delivery of the package to the receiver is not designated and if the drone 10 arrives at the designated delivery location as the destination and the altitude of the drone 10 at the destination reaches 50 centimeters (cm) from ground, for example.

The storage unit 68 is a storage device that stores therein a program, data, and the like that are used by the control unit 60. As the storage unit 68, at least one of a non-volatile semiconductor memory and a volatile semiconductor memory, such as a Read Only Memory (RAM), a Random Access Memory (ROM), a flash memory, an Erasable Programmable Read Only Memory (EPROM), and an Electrically Erasable Programmable Read Only Memory (EEPROM), and a magnetic disk is used.

The communication control unit 69 controls the communication unit 59 and controls communication with the drone 10 and the terminal apparatus 70. More specifically, in the present embodiment, the communication control unit 69 acquires the designated delivery location information and various kinds of information from the terminal apparatus 70 or an external apparatus when the order receipt processing unit 61 receives the order for delivery of the package.

A process performed by the communication control unit 69 at the time of receipt of the order for delivery of the package will be described below. The communication control unit 69 transmits the delivery code to the terminal apparatus 70 that is designated by an orderer of the package at the time or after the order receipt processing unit 61 receives the order for delivery of the package. The terminal apparatus 70 that is designated by the orderer of the package may be terminal apparatus by which the order of the package is placed. The communication control unit 69, when the order receipt processing unit 61 receives the order for package delivery or after receipt of the order, transmits the delivery code to that is designated for delivery.

A process performed by the communication control unit 69 at the time of delivery of the package will be described below. The communication control unit 69 receives from the delivery preparation completion information from the drone 10 that is designated for delivery. The communication control unit 69 transmits information indicating a delivery instruction to the drone 10 that is designated for delivery. The communication control unit 69 receives the information indicating that the delivery acceptable condition is met from the drone 10. The communication control unit 69, when receiving the information indicating that the delivery acceptable condition is met from the drone 10, transmits the delivery acceptable notice to the terminal apparatus 70. The communication control unit 69 receives, from the terminal apparatus 70, information indicating whether or not the delivery code that the terminal apparatus 70 has acquired from the package delivery control apparatus 50 and the delivery code that the terminal apparatus 70 has acquired by receiving the light applied from the irradiation control unit 25 of the drone 10 via the light reception control unit 81 match with each other. The communication control unit 69 transmits the release operation approval information indicating that the right to release the package is granted to the terminal apparatus 70. The communication control unit 69 receives, as the operation information from the terminal apparatus 70, for example, designation of the release operation. The communication control unit 69 transmits, as the operation information from the drone control unit 63, the operation information indicating designation of the release operation to the drone 10, for example. The communication control unit 69, when termination of the package delivery process, transmits a delivery completion notice to the terminal apparatus 70.

### Terminal Apparatus

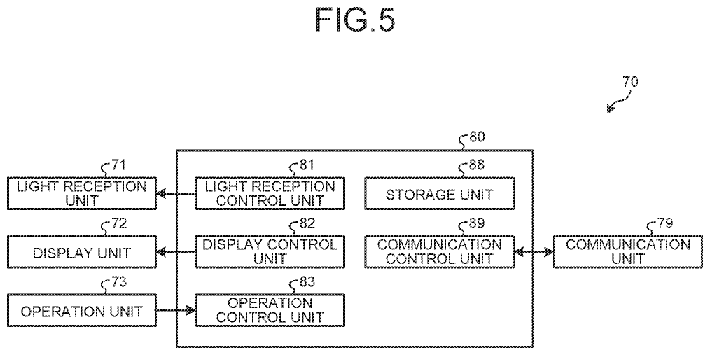

FIG. 5 is a block diagram of the terminal apparatus 70. More specifically, the terminal apparatus 70 is a terminal apparatus that is operated by a receiver who receives the package at the destination. The terminal apparatus 70 is, for example, a mobile electronic device, such as a smartphone. The terminal apparatus 70 is able to receive the package when receiving the delivery acceptable notice for the package. The terminal apparatus 70 is able to operate the drone 10 at the time of receipt of the package. More specifically, the right to release the package is granted to the terminal apparatus 70 at the time of receipt of the package. In the present embodiment, the right to finely adjust the position of the drone 10 may be granted to the terminal apparatus 70, in addition to the right to release the package. The terminal apparatus 70 is able to communicate information with the package delivery control apparatus 50 via the network. The terminal apparatus 70 includes a light reception unit 71, a display unit 72, an operation unit 73, a communication unit 79, and a control unit 80.

The light reception unit 71 is a light reception unit for optical wireless communication. The light reception unit 71 receives, for example, LED light. The light reception unit 71 receives light that is emitted by the drone 10. More specifically, the light reception unit 71 receives the delivery code superimposed light. The light reception unit 71 may be a camera that is included in the terminal apparatus 70.

The display unit 72 is, for example, a display including a liquid crystal display, an Electro-Luminescence (EL) display, or the like. The display unit 72 displays a video based on a video signal that is output from a display control unit 82 of the control unit 80. If the right to release the package is granted, the display unit 72 displays, for example, a release instruction screen of the drone 10 or the like.

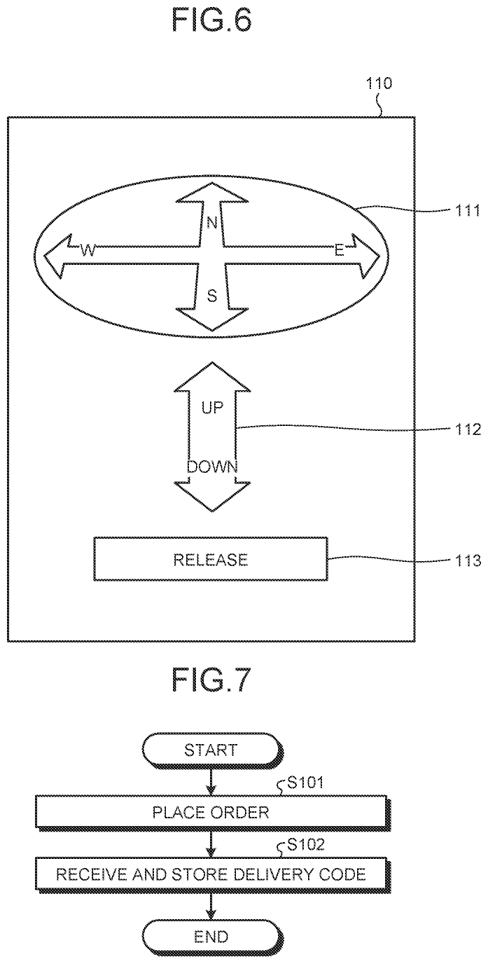

FIG. 6 is a diagram illustrating an example of a release instruction screen 110 that is displayed on the display screen. In the release instruction screen illustrated in FIG. 6, it is possible to finely adjust the position of the drone 10. The release instruction screen 110 includes, for example, a horizontal arrow image 111 for operating fine adjustment of the position of the drone 10 in a horizontal plane, a vertical arrow image 112 for operating fine adjustment of the position in a vertical direction, and a release button image 113 for operating release of package. The horizontal arrow image 111 is an image of arrows indicating east, west, north, and south. When the drone 10 is moved in a predetermined direction along the horizontal direction, touch operation is performed on the moving direction in the horizontal arrow image 111. The vertical arrow image 112 is an image of arrows indicating top and bottom. When the drone 10 is moved in the vertical direction, touch operation is performed on the moving direction in the vertical arrow image 112. When package are released from the drone 10, touch operation is performed on the release button image 113.

When the right to release the package is granted, the operation unit 73 that is a touch panel included in the display unit 72 is able to receive, for example, various kinds of operation for remotely operating the drone 10. The operation unit 73 is able to receive operation for, for example, moving the drone 10 in a predetermined direction along the horizontal direction. The operation unit 73 is able to receive operation for, for example, moving the drone 10 in the vertical direction. The operation unit 73 is able to receive operation for, for example, releasing package from the drone 10. The operation unit 73 outputs operation information to an operation control unit 83 of the control unit 80.

The receiver of the package operates the drone 10 via the release instruction screen displayed on the display unit 72 to move the package to a package place and performs operation for releasing the package.

An adjustment range of the drone 10 used by the terminal apparatus 70 is limited to, for example, less than 1 m in the horizontal direction, less than 1 m in the vertical direction, or the like. Collision prevention by the camera 13 of the drone 10, an altitude sensor (not illustrated), or the like is, of course, is prioritized.

The communication unit 79 is a communication unit that performs wide area wireless communication. The communication unit 79 communicates information with the package delivery control apparatus 50 via a network, for example. The network is, for example, the Internet network, but not limited thereto. The communication unit 79 is configured with, for example, a wide area wireless communication module for a mobile phone network. The communication unit 79 may be configured with a communication module for Wi-Fi, or the like, and may realize wide area wireless communication by connecting to an arbitrary access point, a different smartphone, or the like.

### Control Unit

The control unit 80 is, for example, an arithmetic processing device (control device) that includes a CPU or the like. The control unit 80 loads a stored program onto a memory and executes a command that is included in the program. The control unit 80 includes an internal memory (not illustrated), and the internal memory is used to temporarily store therein data for the control unit 80. The control unit 80 controls the terminal apparatus 70. The control unit 80 includes a light reception control unit 81, the display control unit 82, the operation control unit 83, a storage unit 88, and a communication control unit 89.

The light reception control unit 81 causes the light reception unit 71 to receive light that is emitted from the drone 10. More specifically, the light reception control unit 81 causes the light reception unit 71 to receive the delivery code superimposed light from the drone 10. The light reception control unit 81 acquires a delivery code from the delivery code superimposed light that is received by the light reception unit 71.

The display control unit 82 controls display of a video on the display unit 72 in the display unit 72. The display control unit 82 outputs a video signal for causing the display unit 72 to output a video. More specifically, the display control unit 82, when order for delivery of package is placed, outputs a video signal for displaying an image of a screen for performing the order placement process.

The display control unit 82, when the right to release the package is granted, outputs a video signal for displaying, on the display unit 72, the release instruction screen that instructs release of the package from the drone 10. When the delivery code that is acquired from the package delivery control apparatus 50 and the delivery code that is acquired by receiving light emitted from the irradiation control unit 25 of the drone 10 via the light reception control unit 81 match with each other, the display control unit 82 is granted with the right to release the package and outputs a video signal for displaying the release instruction screen for instructing release of the package. In the present embodiment, the display control unit 82, when the right to release the package is granted by the package delivery control apparatus 50, outputs a video signal for displaying the release instruction screen for instructing release of the package.

When the delivery code that is acquired from the package delivery control apparatus 50 and the delivery code that is acquired by receiving light emitted from the irradiation control unit 25 of the drone 10 via the light reception control unit 81 match with each other, the display control unit 82 may be granted with the right to finely adjust the position of the drone 10, and may output a video signal for displaying, on the display unit 72, the release instruction screen for finely adjusting the position. In the present embodiment, the display control unit 82 may output a video signal for displaying the release instruction screen that allows fine adjustment of the position of the drone 10, when the right to finely adjust the position of the drone 10 is granted by the package delivery control apparatus 50.

The operation control unit 83, at the time of placement of order for package delivery, receives operation of performing the order placement process. In the present embodiment, the operation control unit 83 receives, for example, operation of inputting the designated delivery location information and various kinds of information.

The operation control unit 83, when the delivery code that is acquired from the package delivery control apparatus 50 and the delivery code that is acquired by receiving light emitted from the irradiation control unit 25 of the drone 10 via the light reception control unit 81 match with each other, receives operation for instructing, in the terminal apparatus 70, the drone 10 to perform operation of releasing the package. In the present embodiment, the operation control unit 83, when the right to release the package is granted by the package delivery control apparatus 50, receives operation for instructing, in the terminal apparatus 70, the drone 10 to perform operation of releasing the package.

In the present embodiment, the operation control unit 83, when the right to finely adjust the position of the drone 10 is granted by the package delivery control apparatus 50, may acquire the operation information that indicates operation of finely adjusting the position. More specifically, the operation control unit 83 may acquire, for example, operation information that indicates operation of fine adjustment in a horizontal plane and operation of fine adjustment in the vertical direction for moving the drone 10 to a package release position, and output a control signal.

The operation control unit 83 outputs the acquired operation information as a control signal. The operation information that is acquired by the operation control unit 83 is output from the terminal apparatus 70 to the package delivery control apparatus 50.

The storage unit 88 is a storage device that stores therein a program, data, and the like that are used by the control unit 80. As the storage unit 88, for example, at least one of a non-volatile semiconductor memory and a volatile semiconductor memory, such as a RAM, a ROM, a flash memory, an EPROM, and an EEPROM, is used.

The communication control unit 89 controls the communication unit 79 and controls communication with the package delivery control apparatus 50. In the present embodiment, the communication control unit 89, at the time of placement of order for package delivery, transmits various kinds of information, such as the designated delivery location information and package information, to the package delivery control apparatus 50. The communication control unit 89 receives a delivery code from the package delivery control apparatus 50. The communication control unit 89, when the delivery code that is acquired from the package delivery control apparatus 50 and the delivery code that is acquired by receiving light emitted from the irradiation control unit 25 of the drone 10 via the light reception control unit 81 match with each other, transmits information indicating that the delivery codes match to the package delivery control apparatus 50. The communication control unit 89 receives the delivery acceptable notice from the package delivery control apparatus 50. The communication control unit 89 receives the release operation approval information from the package delivery control apparatus 50. The communication control unit 89 transmits operation information that is acquired by the operation control unit 83 to the package delivery control apparatus 50. The communication control unit 89 transmits, for example, operation information that is acquired by the operation control unit 83 to the package delivery control apparatus 50. The communication control unit 89 transmits, for example, operation information that indicates designation of the release operation to the package delivery control apparatus 50. The communication control unit 89 transmits, for example, operation information that indicates operation of fine adjustment to the package delivery control apparatus 50. The communication control unit 89, if the package delivery process is terminated, receives the delivery completion notice from the package delivery control apparatus 50.

### Information Processing Performed by Package Delivery System

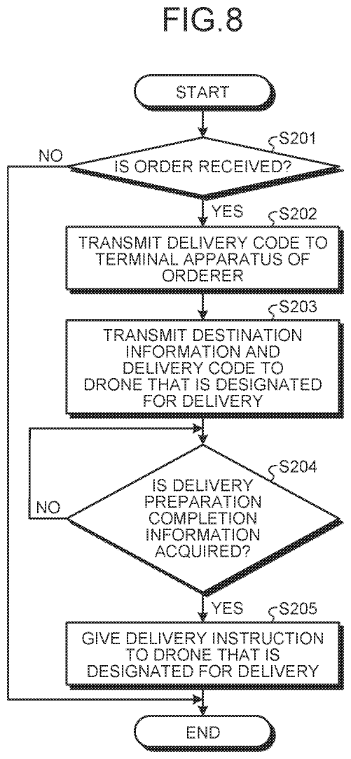

Information processing performed by the package delivery system 1 will be described below with reference to FIG. 7 to FIG. 11. First, the order placement process and the order receipt process for a package will be described with reference to FIG. 7 and FIG. 8. FIG. 7 is a diagram illustrating the flow of the order placement process performed by the terminal apparatus 70 that has placed an order with the package delivery control apparatus 50 of the package delivery system 1 according to the first embodiment for a package.

The terminal apparatus 70 places an order for package delivery (Step S101). More specifically, the control unit 80 causes the display control unit 82 to display an image of a screen for performing the order placement process on the display unit 72. The control unit 80 causes the operation control unit 83 to receive operation for performing the order placement process. The control unit 80 causes the operation control unit 83 to, for example, receive operation of inputting the designated delivery location information and various kinds of information. The control unit 80 causes the communication control unit 89 to transmit various kinds of information, such as the designated delivery location information and the package information, to the package delivery control apparatus 50 at the time of placement of order for package delivery. The control unit 80 goes to Step S102.

The terminal apparatus 70 receives the delivery code from the package delivery control apparatus 50 that has received the order placed at Step S101, and stores the delivery code (Step S102). More specifically, the terminal apparatus 70 receives the delivery code that can uniquely identify order details from the package delivery control apparatus 50.

FIG. 8 is a diagram illustrating the flow of the order receipt process performed by the package delivery control apparatus 50 of the package delivery system 1 according to the first embodiment.

The control unit 60 determines whether or not an order is received (Step S201). More specifically, the control unit 60 causes the communication control unit 69 to determine whether various kinds of information, such as the designated delivery location information and the package information, is acquired from the terminal apparatus 70. The control unit 60, when the order receipt process is performed online, such as when various kinds of information, such as the designated delivery location information and the package information, is acquired from the terminal apparatus 70, determines that an order is received. If it is determined that an order is received (Yes at Step S201), the control unit 60 goes to Step S202. If it is not determined that an order is received (No at Step S201), the control unit 60 terminates the process.

If it is determined that an order is received (Yes at Step S201), the control unit 60 transmits the delivery code to the terminal apparatus 70 of the orderer (Step S202). More specifically, the control unit 60 causes the communication control unit 69 to transmit the delivery code to the terminal apparatus 70 of the orderer. The control unit 60 goes to Step S203.

The control unit 60 transmits the destination information and the delivery code to the drone 10 that is designated for delivery (Step S203). More specifically, the control unit 60 causes the communication control unit 69 to transmit the delivery code to the drone 10 that is designated for delivery. The control unit 60 goes to Step S204.

The control unit 60 determines whether or not the delivery preparation completion information is acquired (Step S204). The control unit 60 causes the communication control unit 69 to determine whether or not the delivery preparation completion information is received from the drone 10 that is designated for delivery. The delivery preparation completion indicates a state in which the package to be delivered is held by the drone 10 and delivery is ready. If it is determined that the delivery preparation completion information is acquired (Yes at Step S204), the control unit 60 goes to Step S205. If it is not determined that the delivery preparation completion information is acquired (No at Step S204), the control unit 60 performs the process at Step S204 again.

If the delivery preparation in the drone 10 that is designated for delivery is completed, the control unit 60 gives a delivery instruction (Step S205). More specifically, the control unit 60 causes the communication control unit 69 to transmit information indicating the delivery instruction to the drone 10 that is designated for delivery. The delivery instruction is an instruction given to the drone 10 to start flight to the destination.

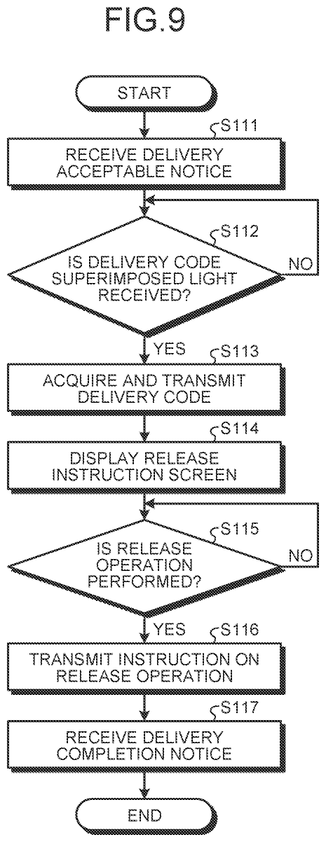

The delivery process will be described below with reference to FIG. 9 to FIG. 11. FIG. 9 is a diagram illustrating the flow of the delivery process performed by the terminal apparatus 70 that has placed an order with the package delivery control apparatus 50 of the package delivery system 1 according to the first embodiment for a package.

The control unit 80 receives the delivery acceptable notice (Step S111). More specifically, the control unit 80 causes the communication control unit 89 to receive the delivery acceptable notice from the package delivery control apparatus 50. The delivery acceptable notice is transmitted from the package delivery control apparatus 50 to the terminal apparatus 70 when the drone 10 arrives at the destination or the vicinity of the destination. The user of the terminal apparatus 70, when receiving the delivery acceptable notice, checks the drone 10 at the designated delivery location that is the destination of the drone 10, and turns the terminal apparatus 70 toward the drone 10 such that the terminal apparatus 70 can receive the delivery code superimposed light. The delivery acceptable notice may include a notice indicating a request for reception of the delivery code superimposed light in addition to a notice indicating that the drone 10 has arrived at the designated delivery location or the vicinity of the designated delivery location. The control unit 80 goes to Step S112.

The control unit 80 determines whether or not the delivery code superimposed light is received (Step S112). More specifically, the control unit 80 confirms whether the light received by the light reception control unit 81 includes the delivery code, and if the delivery code is included, the control unit 80 determines that the delivery code superimposed light is received. The control unit 80 goes to Step S113.

The control unit 80 acquires and transmits the delivery code (Step S113). More specifically, the control unit 80 causes the light reception control unit 81 to acquire the delivery code by decoding the code in the received delivery code superimposed light. The control unit 80, after acquiring the delivery code from the delivery code superimposed light, compares the delivery code with the delivery code that is transmitted from the package delivery control apparatus 50, and determines whether the delivery codes match with each other. The control unit 80 causes the communication control unit 89 to transmit, to the package delivery control apparatus 50, information indicating that the delivery codes match with each other when the delivery code that is acquired from the package delivery control apparatus 50 and the delivery code that is acquired by receiving light emitted from the irradiation control unit 25 of the drone 10 match with each other. The control unit 80 goes to Step S114.

The control unit 80 displays the release instruction screen (Step S114). More specifically, the control unit 80 causes the display control unit 82 to output a video signal for displaying, on the display unit 72, the release instruction screen for designating the operation of releasing the package from the drone 10. The control unit 80 does not display the release instruction screen when the delivery code that is acquired from the package delivery control apparatus 50 and the delivery code that is acquired by receiving light emitted from the irradiation control unit 25 of the drone 10 do not match with each other. The control unit 80 goes to Step S115.

The control unit 80 determines whether or not the release operation is performed (Step S115). More specifically, when the operation control unit 83 has received operation for assisting the drone 10 in operation of releasing the package, the control unit 80 determines that the release operation is performed. If it is determined that the release operation is performed (Yes at Step S115), the control unit 80 goes to Step S116. If it is not determined that the release operation is performed (No at Step S115), the control unit 80 performs the process at Step S115 again.

The control unit 80 transmits an instruction on the release operation (Step S116). More specifically, the control unit 80 causes the communication control unit 89 to transmit, for example, information indicating an instruction on the release operation to the package delivery control apparatus 50. The control unit 80 goes to Step S117.

The control unit 80 receives the delivery completion notice (Step S117). More specifically, the control unit 80 causes the communication control unit 89 to receive the delivery completion notice from the package delivery control apparatus 50.

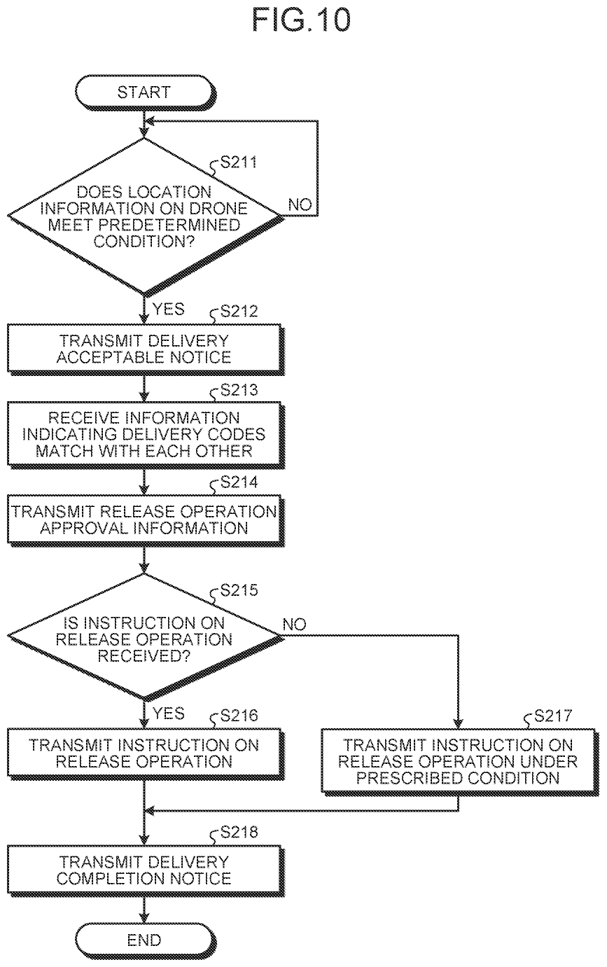

FIG. 10 is a diagram illustrating the flow of the delivery process performed by the package delivery control apparatus 50 of the package delivery system 1 according to the first embodiment.

The control unit 60 determines whether the location information on the drone 10 meets the delivery acceptable condition (Step S211). More specifically, when the communication control unit 69 has received the information indicating that the delivery acceptable condition is met from the drone 10, the control unit 60 determines that the delivery acceptable condition is met. If it is determined that the delivery acceptable condition is met (Yes at Step S211), the control unit 60 goes to Step S212.

The control unit 60 transmits the delivery acceptable notice (Step S212). More specifically, the control unit 60 causes the communication control unit 69 to transmit the delivery acceptable notice to the terminal apparatus 70. The control unit 60 goes to Step S213.

The control unit 60 receives the information indicating that the delivery codes match with each other (Step S213). More specifically, the control unit 60 causes the communication control unit 69 to receive, from the terminal apparatus 70, the information indicating the delivery code that the terminal apparatus 70 has acquired from the package delivery control apparatus 50 and the delivery code that the terminal apparatus 70 has acquired by receiving the light applied from the irradiation control unit 25 of the drone 10 via the light reception control unit 81 match with each other. The control unit 60 goes to Step S214. At Step S213, it may be possible to receive, from the terminal apparatus 70, the delivery code that the terminal apparatus 70 has acquired from the package delivery control apparatus 50 and the delivery code that is acquired by receiving light emitted from the drone 10, and the control unit 60 may determine whether or not the two delivery codes match with each other.

The control unit 60 transmits the release operation approval information (Step S214). More specifically, the control unit 60 causes the communication control unit 69 to transmit the release operation approval information indicating that the right to release the package is granted to the terminal apparatus 70. The control unit 60 goes to Step S215.

The control unit 60 determines whether or not the instruction on the release operation is received (Step S215). More specifically, the control unit 60 causes the communication control unit 69 to determine whether the instruction on the release operation is received as the operation information from the terminal apparatus 70. If it is determined that the instruction on the release operation is received (Yes at Step S215), the control unit 60 goes to Step S216. If it is not determined that the instruction on the release operation is received (Yes at Step S215), the control unit 60 goes to Step S217. As the process at Step S215, it may be possible to determine whether the instruction on the release operation is received for a predetermined time, such as 60 seconds, since transmission of the release operation approval information at Step S214.

If it is determined that the instruction on the release operation is received (Yes at Step S215), the control unit 60 transmits the instruction on the release operation (Step S216). More specifically, the control unit 60 causes the communication control unit 69 to transmit, to the drone 10, operation information indicating the instruction on the release operation as the operation information from the drone control unit 63, for example. The control unit 60 goes to Step S218.

If it is not determined that the instruction on the release operation is not received (No at Step S215), the control unit 60 transmits an instruction on the release operation under the prescribed condition (Step S217). More specifically, the control unit 60 causes the communication control unit 69 to transmit, to the drone 10, operation information indicating an instruction on the release operation on condition that the prescribed condition is met, as the operation information from the drone control unit 63, for example. The control unit 60 goes to Step S218.

The control unit 60 transmits the delivery completion notice (Step S218). More specifically, the control unit 60 causes the communication control unit 69 to transmit the delivery completion notice to the terminal apparatus 70.

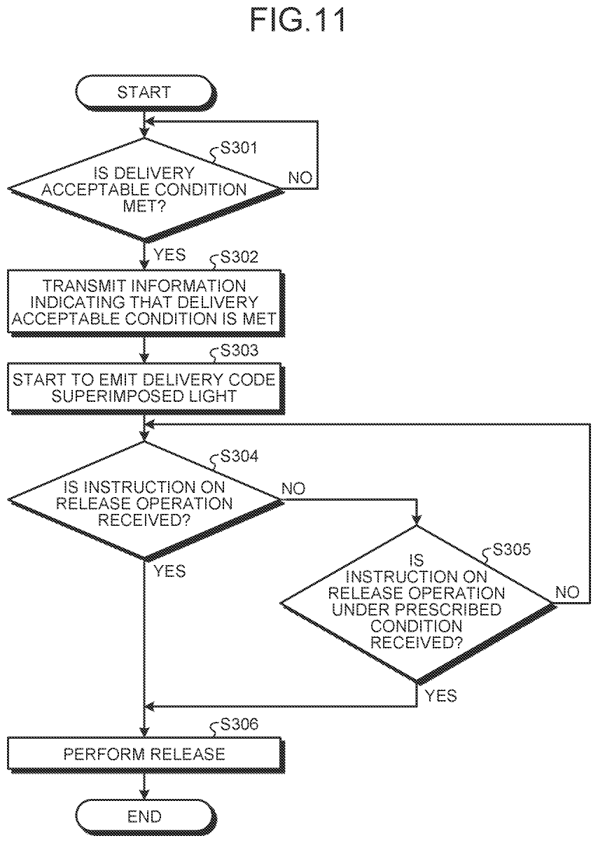

FIG. 11 is a diagram illustrating the flow of the delivery process performed by the drone 10 of the package delivery system 1 according to the first embodiment.

The control unit 20 determines whether or not the delivery acceptable condition is met based on the current location and the designated delivery location (Step S301). More specifically, when the location information on the drone 10 matches with the designated delivery location information indicating the latitude and the longitude of the destination based on the location information that is acquired by the location information acquisition unit 21 and the designated delivery location information that is included in the delivery code, the control unit 20 causes the autonomous flight control unit 26 determines that the drone 10 has arrived at the destination, in other words, the delivery acceptable condition is met. If it is determined that the current location and the designated delivery location meet the delivery acceptable condition (Yes at Step S301), the control unit 20 goes to Step S302. If it is not determined that the current location and the designated delivery location meet the delivery acceptable condition (No at Step S301), the control unit 20 performs the process at Step S301 again.

The control unit 20 transmits information indicating that the delivery acceptable condition is met (Step S302). More specifically, the control unit 20 causes the communication control unit 29 to transmit the information indicating that the delivery acceptable condition is met to the package delivery control apparatus 50.

The control unit 20 starts to emit the delivery code superimposed light (Step S303). More specifically, the control unit 20 causes the irradiation control unit 25 to cause the light source unit 14 of the drone 10 to emit the delivery code superimposed light. The control unit 20 goes to Step S304.

The control unit 20 determines whether or not the instruction on the release operation is received (Step S304). More specifically, the control unit 20 causes the communication control unit 29 to determine whether or not the operation information that is input from the package delivery control apparatus 50 to the terminal apparatus 70, for example, operation information indicating the instruction on the release operation, is received. If it is determined that the instruction on the release operation is received (Yes at Step S304), the control unit 20 goes to Step S305. If it is not determined that the instruction on the release operation is received (No at Step S304), the control unit 20 goes to Step S306.

The control unit 20 determines whether or not the instruction on the release operation under the prescribed condition is received (Step S305). If it is determined that the instruction on the release operation under the prescribed condition is received (Yes at Step S305), the control unit 20 goes to Step S306. If it is not determined that the instruction on the release operation under the prescribed condition is received (Yes at Step S305), the control unit 20 performs the process at Step S304 again.

The control unit 20 releases the package (Step S306). More specifically, the control unit 20 causes the release control unit 28 to perform operation of releasing the package based on the received operation information that indicates the instruction on the release operation.

### Effects

As described above, in the present embodiment, when the delivery code that the terminal apparatus 70 has acquired from the package delivery control apparatus 50 and the delivery code that the terminal apparatus 70 has acquired by receiving light emitted from the drone 10 match with each other, it is possible to receive operation for instructing, in the terminal apparatus 70, the drone 10 to perform operation of releasing the package. According to the present embodiment, it is possible to receive the package delivered by the drone 10, based on a decision of a receiver via the terminal apparatus 70. According to the present embodiment, it is possible to prevent the package released from the drone 10 from unintentionally fall or from being placed at an inappropriate location. According to the present embodiment, if impact resistance of the package is low for example, it is possible for the receiver to manually secure the package in a safe place.

In the present embodiment, the terminal apparatus 70 is able to perform operation of instructing the drone 10 to perform operation of releasing the package and receive operation of finely adjusting a delivery position of the package. According to the present embodiment, it is possible to receive the package at an appropriate position while finely adjusting the position.

### Second Embodiment

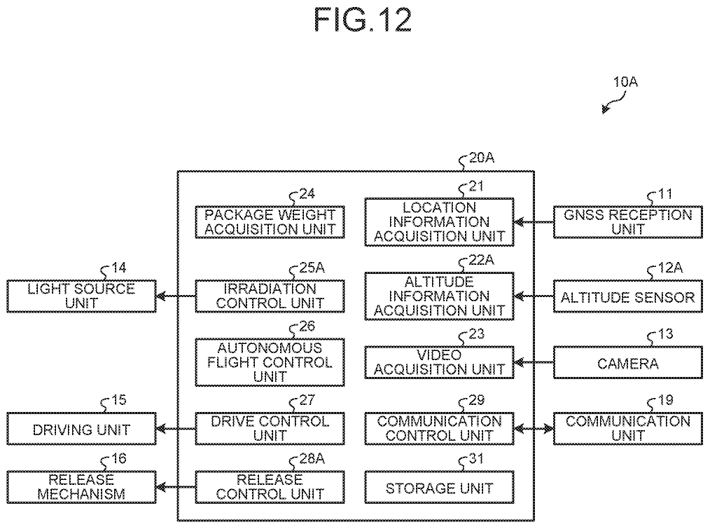

A package delivery system 1 according to a second embodiment will be described below with reference to FIG. 12. FIG. 12 is a schematic diagram of a drone 10A according to the second embodiment. A basic configuration of the drone 10A of the second embodiment is the same as that of the drone 10 of the first embodiment. In the description below, the same components as those of the drone 10 of the first embodiment will be denoted by the same or corresponding reference symbols, and detailed explanation thereof will be omitted. The drone 10A is different from the first embodiment in that an altitude sensor 12A and an altitude information acquisition unit 22A are included and an irradiation control unit 25A and a release control unit 28A perform different processes.

The altitude sensor 12A is a sensor that detects a flight altitude of the drone 10A from ground. The altitude sensor 12A is, for example, a sensor that is arranged so as to be oriented below the drone 10A and that uses ultrasound, infrared, or the like. As the altitude sensor 12A, the light source unit 14 may be used as a sensor that detects the flight altitude. The altitude sensor 12A outputs detected sensor data to the altitude information acquisition unit 22A.

The altitude information acquisition unit 22A acquires flight altitude information on the drone 10A. More specifically, the altitude information acquisition unit 22A acquires the sensor data from the altitude sensor 12A. The altitude information acquisition unit 22A may acquire the flight altitude from, for example, a reflection time of ultrasound, infrared, or the like that is emitted toward the ground. The altitude information acquisition unit 22A may acquire the flight altitude from, for example, the reflection time of the delivery code superimposed light that is emitted from the light source unit 14.

The irradiation control unit 25A changes an altitude at which the light is emitted, based on a weight of the package that is acquired by a package weight acquisition unit 24A. The irradiation control unit 25A, when the weight of the package is large, causes the light source unit 14 of the drone 10A to emit the delivery code superimposed light at a lower flight altitude as compared to a case in which the weight of the package is small. For example, if the weight of the package is smaller than 1 kilogram (kg), the irradiation control unit 25A causes the light source unit 14 of the drone 10A to emit the delivery code superimposed light while the flight altitude of the drone 10A is 150 cm. For example, if the weight of the package is equal to or larger than 1 kg and equal to or smaller than a drone deliverable weight, the irradiation control unit 25A causes the light source unit 14 of the drone 10A to emit the delivery code superimposed light while the flight altitude of the drone 10A is 50 cm.

The release control unit 28A changes an altitude at which the operation of releasing the package is enabled, based on the weight of the package that is acquired by the package weight acquisition unit 24A. If the weight of the package is large, the release control unit 28A enables release of the package at a low flight altitude as compared to a case in which the weight of the package is small. For example, if the weight of the package is smaller than 1 kg, the release control unit 28A does not enable the release operation until the altitude reaches 150 cm even if the release operation is received while the flight altitude of the drone 10A is above 150 cm, and enables the release operation when the flight altitude reaches 150 cm or less. For example, if the weight of the package is equal to or larger than 1 kg and equal to or smaller than a drone deliverable weight, the release control unit 28A does not enable the release operation until the altitude reaches 150 cm even if the release operation is received while the flight altitude of the drone 10A is above 150 cm, and enables the release operation when the flight altitude reaches 150 cm or less.

As described above, in the present embodiment, it is possible to change an altitude at which the delivery code superimposed light is emitted, based on a weight of the package. According to the present embodiment, it is possible to more safely receive the package depending on the weight of the package.

In the present embodiment, it is possible to change an altitude at which the operation of releasing the package is enabled, based on the weight of the package. According to the present embodiment, it is possible to more safely receive the package depending on the weight of the package.

### Third Embodiment

In the first embodiment and the second embodiment as described above, the configuration and the process of the package delivery system 1 that includes the drone 10 and the package delivery control apparatus 50 have been described as an example of the package delivery system 1 according to the present disclosure. The processes in the first embodiment and the second embodiment as described above may be performed by the package delivery control apparatus 50.

Specifically, as for the process that the irradiation control unit 25 performs to emit the delivery code superimposed light from the drone 10 when the drone 10 arrives at the destination, the drone control unit 63 of the package delivery control apparatus 50 may determine that the drone 10 has arrived at the destination based on the location information on the drone 10 and the destination information, and cause the irradiation control unit 25 of the drone 10 to give an instruction to emit the delivery code superimposed light from the drone 10.

Further, the package delivery control apparatus 50 may acquire the flight altitude information that is acquired by the altitude information acquisition unit 22A of the drone 10, and the drone control unit 63 of the package delivery control apparatus 50 may perform control of changing an altitude at which the delivery code superimposed light is emitted or control of changing an altitude at which release operation is enabled based on the weight of the package.

As described above, by causing the package delivery control apparatus 50 to perform the processes, the package delivery control apparatus 50 of according to the present embodiment is configured as described below. The package delivery control apparatus 50 includes the terminal apparatus 70 that is designated by an orderer who places an order for package delivery, the communication control unit 69 that controls communication with the drone 10 that delivers the package, and the drone control unit 63 that controls operation of the drone 10 by communication performed by the communication control unit 69. The communication control unit 69, when receiving an order for delivery of the package, transmits a delivery code that includes designated delivery location information on the package to the terminal apparatus 70 that is designated by an orderer of the package. The drone control unit 63, when the drone 10 that delivers the package arrives at a destination that is based on designated delivery location information on the package, causes the drone 10 to emit light in which the delivery code is superimposed, approves the terminal apparatus 70 to cause the drone 10 to perform operation of releasing the package from the drone 10 when acquiring information indicating that the delivery code that the terminal apparatus 70 has acquired by transmission from the communication control unit 69 and the delivery code that the terminal apparatus 70 has acquired by receiving light emitted from the drone 10 match with each other, and instructs the drone 10 to perform operation of releasing the package based on information that indicates the operation of releasing the package and that is received from the terminal apparatus 70.

Furthermore, as another configuration, in the package delivery control apparatus 50 as described above, the drone control unit 63 performs control of changing a flight altitude at which the drone 10 emits light in which the delivery code is superimposed, based on the weight of the package that is delivered by the drone 10. Alternatively, in the package delivery control apparatus 50 as described above, the drone control unit 63 performs control of changing a flight altitude at which operation of releasing the package that is delivered by the drone 10 is enabled, based on the weight of the package that is delivered by the drone 10.

As still another configuration, when the delivery code that the terminal apparatus 70 has acquired by transmission from the communication control unit 29 and the delivery code that the terminal apparatus 70 has acquired by receiving light emitted from the drone 10 match with each other, the drone control unit 63 approves the terminal apparatus 70 for operation of causing the drone 10 to finely adjust a delivery position of the package, and instructs the drone 10 to perform the release operation after finely adjusting the delivery position of the package based on the information that indicates operation of finely adjusting the delivery position and that is received from the terminal apparatus 70.

The components of the package delivery system illustrated in the drawings are functionally conceptual and do not necessarily have to be physically configured in the manner illustrated in the drawings. In other words, specific forms of each of the apparatuses are not limited to those illustrated in the drawings, and all or part of the apparatuses may be functionally or physically distributed or integrated in arbitrary units depending on various loads or use conditions of each of the apparatuses.

The configuration of the package delivery system may be implemented as, for example, software by a program or the like that is loaded on a memory. In the embodiments as described above, functional blocks that are implemented by cooperation of hardware or software have been described. In other words, the functional blocks may be implemented by various forms by only hardware, by only software, or by a combination of hardware and software.

The components described above include one that can easily be thought of by a person skilled in the art and one that is practically identical. Furthermore, the configurations described above may be combined appropriately. Moreover, within the scope not departing from the gist of the following embodiments, various omission, replacement, and modifications of the components may be made.

For example, the units included in the control unit 60 of the package delivery control apparatus 50 may be distributed and implemented in the drone 10 and the terminal apparatus 70. More specifically, a part of the units included in the control unit 60 of the package delivery control apparatus 50 may be arranged in the control unit 20 of the drone 10, and the rest of the units may be arranged in the control unit 80 of the terminal apparatus 70.

It the above description, it is explained that the drone 10 autonomously flies; however, when an operator performs operation, the operator may operate a remote controller while viewing a video that is captured by the camera 13 included in the drone 10 and causes the drone 10 to fly to the destination.

The present disclosure includes a matter that contributes to realization of “Build resilient infrastructure, promote inclusive and sustainable industrialization and foster innovation” of Sustainable Development Goals (SDGs) and contributes to value creation by IoT solutions.

The present disclosure is applicable to, for example, a system that delivers a package by using the drone 10.

According to the present disclosure, it is possible to receive a package that is delivered by a drone based on a decision of a receiver.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A package delivery system that includes:
a drone that delivers a package by adopting a designated delivery location of the package as a destination; and
a package delivery control apparatus that is able to perform communication with the drone and a terminal apparatus that is designated by an orderer of the package,
the package delivery system comprising:
a communication control unit that transmits a delivery code of the package to the terminal apparatus when receiving an order for delivery of the package;
an irradiation control unit that causes the drone to emit light in which the delivery code is superimposed when the drone arrives at the destination;
a drone control unit that, when the delivery code that the terminal apparatus has acquired by transmission from the communication control unit and the delivery code that the terminal apparatus has acquired by receiving light emitted from the drone match with each other, approves the terminal apparatus to cause the drone to perform operation of releasing the package, and instructs the drone to release the package based on information that indicates operation of releasing the package and that is received from the terminal apparatus; and
a release control unit that, when receiving, from the package delivery control apparatus, information that indicates operation of releasing the package, performs control so as to perform operation of releasing the package.

2. The package delivery system according to claim 1, wherein
the drone includes an altitude information acquisition unit that acquires flight altitude information, and
the irradiation control unit changes an altitude at which the light is emitted, based on a weight of the package.

3. The package delivery system according to claim 1, wherein
the drone includes an altitude information acquisition unit that acquires flight altitude information, and
the release control unit changes an altitude at which operation of releasing the package is enabled, based on a weight of the package.

4. The package delivery system according to claim 1, wherein
when the delivery code that the terminal apparatus has acquired by transmission from the communication control unit and the delivery code that the terminal apparatus has acquired by receiving light emitted from the drone match with each other, the drone control unit approves the terminal apparatus for operation of causing the drone to finely adjust a delivery position of the package, and
the release control unit, when receiving information that indicates operation of finely adjusting the delivery position, performs control so as to perform release operation after finely adjusting the delivery position of the package.

5. A package delivery control apparatus comprising:
a communication control unit that controls communication between a terminal apparatus that is designated by an orderer who places an order for delivery of a package and a drone that delivers the package; and
a drone control unit that controls operation of the drone by communication performed by the communication control unit, wherein
the communication control unit, when receiving an order for delivery of the package, transmits a delivery code that includes designated delivery location information on the package to the terminal apparatus that is designated by an orderer of the package, and
the drone control unit, when the drone that delivers the package arrives at a destination that is based on the designated delivery location information on the package, causes the drone 10 to emit light in which the delivery code is superimposed, approves the terminal apparatus to cause the drone to perform operation of releasing the package when acquiring information indicating that the delivery code that the terminal apparatus has acquired by transmission from the communication control unit and the delivery code that the terminal apparatus has acquired by receiving light emitted from the drone match with each other, and instructs the drone to perform operation of releasing the package based on information that indicates the operation of releasing the package and that is received from the terminal apparatus.

6. The package delivery control apparatus according to claim 5, wherein
the communication control unit acquires flight altitude information on the drone, and
the drone control unit causes the drone to change an altitude at which the light is emitted, based on a weight of the package.

7. The package delivery control apparatus according to claim 5, wherein
the communication control unit acquires flight altitude information on the drone, and
the drone control unit causes the drone to change an altitude at which operation of releasing the package is enabled, based on a weight of the package.

8. The package delivery control apparatus according to claim 5, wherein
the drone control unit, when acquiring information indicating that the delivery code that the terminal apparatus has acquired by transmission from the communication control unit and the delivery code that the terminal apparatus has acquired by receiving light emitted from the drone match with each other, approves the terminal apparatus for operation of causing the drone to finely adjust a delivery position of the package, and when receiving, from the terminal apparatus, information that indicates operation of finely adjusting the delivery position, instructs the drone to finely adjust the delivery position of the package.

9. A package delivery method implemented by a package delivery control apparatus that is able to perform communication with a terminal apparatus that is designated by an orderer who places an order for delivery of a package and a drone that delivers the package, the package delivery method comprising:
transmitting a delivery code of the package to the terminal apparatus when receiving an order for delivery of the package;
causing the drone to emit light in which the delivery code is superimposed when the drone arrives at the destination;
approving, when the delivery code that the terminal apparatus has acquired at the time of the order of the package and the delivery code that the terminal apparatus has acquired by receiving light emitted from the drone match with each other, the terminal apparatus to cause the drone to perform operation of releasing the package; and
instructing the drone to release the package based on information that indicates operation of releasing the package and that is received from the terminal apparatus.
